(19) United States
(12) Patent Application Publication
(10) Pub. No.: US 2025/0361986 A1
(43) Pub. Date: Nov. 27, 2025

(54) APPARATUS AND METHOD FOR DISPENSING A LIQUEFIED FLUID INTO A CONTAINER

(71) Applicant: KRONES AG, Neutraubling (DE)

(72) Inventors: Bernd SCHAFACZEK, Falkenstein (DE); Udo DONHAUSER, Bodenwoehr (DE); Michael PETER, Siegenburg (DE); Frank FISCHER, Krefeld (DE); Juergen SOELLNER, Beratzhausen (DE)

(21) Appl. No.: 19/213,318

(22) Filed: May 20, 2025

(30) Foreign Application Priority Data
May 21, 2024 (DE) 10 2024 114 205.7

(51) Int. Cl. F17C 5/04; F17C 13/04

(52) U.S. Cl. CPC F17C 5/04; F17C 13/04; F17C 2221/03

(57) ABSTRACT

The invention relates, inter alia, to an apparatus for dispensing a liquefied fluid into a container. The apparatus has a cooling container for receiving a cooling medium. The apparatus has a liquefaction device arranged in the cooling container for cooling and liquefying a gaseous fluid. The apparatus has a storage container which is connected to the liquefaction device for receiving the liquefied fluid from the liquefaction device and which is arranged in the cooling container for cooling the liquefied fluid. The apparatus has a dosing device for dispensing the liquefied fluid into the container, wherein the dosing device is connected to the storage container for receiving the liquefied fluid from the storage container.

### CROSS-REFERENCE TO RELATED APPLICATIONS

This application claims the benefit under 35 U.S.C. § 119(a) of German Patent Application No. DE 10 2024 114 205.7, filed May 21, 2024, entitled APPARATUS AND METHOD FOR DISPENSING A LIQUEFIED FLUID INTO A CONTAINER, and whose entire disclosure is incorporated by reference herein.

### TECHNICAL FIELD

The invention relates to an apparatus for dispensing a liquefied fluid into a container and to a container treatment plant having the apparatus. The invention further relates to a method for dispensing a liquefied fluid into a container.

### TECHNICAL BACKGROUND

Systems having apparatuses for filling containers have long been known from the prior art. The containers are usually transported along a predetermined transport path, e.g., a circular transport path, and are filled with a pasty or liquid product, e.g., a beverage, during this transport. Liquid nitrogen can also be introduced into the containers. For example, various properties of a plastic container can be improved in this way. For example, the mechanical load capacity (load-bearing capacity, transportability on conveyor belt systems, handling, etc.) can be improved. The shelf life of the filled product can also be improved by displacing oxygen from the headspace of the container. The haptic properties, i.e., the feel of the grip, and other properties can also be improved. Such apparatuses for introducing liquid nitrogen are called “nitrogen droppers” (“nitrogen droppler”), for example, and the process itself is called “dropping” (“droppling”).

For example, DE 10 2010 051 543 A1 discloses an apparatus for filling containers with liquids. A filling element fills the containers with the liquid. A transport device transports the containers along a predetermined transport path. An application device applies a further flowable medium to the containers filled with the liquid. The flowable medium contains, for example, nitrogen.

Disadvantages of conventional apparatuses for delivering a liquefied fluid to a container can include their complexity, the large amount of space required, and the comparatively high maintenance and repair outlay.

The invention is based upon the object of creating an improved technology for dispensing a liquefied fluid into a container. Preferably, the associated apparatus shall be particularly compact.

### SUMMARY OF THE INVENTION

The object is achieved by the features of the independent claims. Advantageous developments are specified in the dependent claims and the description.

One aspect of the present disclosure relates to an apparatus, preferably a nitrogen dropper (droppler), for dispensing a liquefied (e.g., sterile) fluid, preferably (e.g., sterile) nitrogen or (e.g., sterile) oxygen, into a container. The apparatus has an (e.g., pressureless or vacuum) cooling container for holding a, preferably liquid, cooling medium. The apparatus further has a liquefaction device arranged in the cooling container for cooling and liquefying a gaseous fluid (preferably (e.g., sterile) nitrogen or (e.g., sterile) oxygen). The apparatus further has a storage container connected to the liquefaction device for receiving the liquefied fluid from the liquefaction device and arranged in the cooling container for cooling the liquefied fluid. The apparatus further has a dosing device for dispensing the liquefied fluid into the container (e.g., positioned under the dosing device), wherein the dosing device is connected to the storage container for receiving the liquefied fluid from the storage container.

Advantageously, the apparatus can enable a particularly compact structural unit. The condensing device and the storage container can be arranged together in the cooling container and thus jointly use the cooling medium contained therein to cool the fluid. This can also advantageously simplify the line routing in the apparatus. Furthermore, the otherwise critical interface between the condensing device and the storage container can be safely arranged within the cooling container and thus within the cooling medium contained therein. Advantageously, operation of the apparatus can also be simplified, since, for example, only one cooling medium fill level needs to be monitored (and not, for example, two cooling medium fill levels).

Preferably, the storage container can be arranged below the liquefaction device, the dosing device can be arranged below the storage container, and/or the container can be positioned below the dosing device.

In one exemplary embodiment, the apparatus further has a fluid gas source, preferably a sterile fluid gas source, particularly preferably a sterile nitrogen gas source or a sterile oxygen gas source, wherein the fluid gas source is connected to the liquefaction device for supplying the gaseous fluid to the liquefaction device. This can advantageously ensure a reliable supply of gaseous fluid to the liquefaction device.

In a further exemplary embodiment, the apparatus further has a cooling medium source, preferably a cooling liquid source, particularly preferably an (e.g., non-sterile) liquid nitrogen source, wherein the cooling medium source is connected to the cooling container for supplying the cooling medium to the cooling container. This can advantageously ensure a reliable supply of the cooling container with cooling medium.

In one embodiment, the apparatus further has a, preferably thermosensitive, cooling medium fill-level sensor arranged in the cooling container for detecting a fill level of the cooling medium. Advantageously, the fill level of the cooling medium and thus the cooling performance brought about by it can thus be monitored.

In a further embodiment, the apparatus further has a, preferably thermosensitive, liquefied fluid fill-level sensor arranged in the storage container for detecting a fill level of the liquefied fluid. Advantageously, a fill level of the liquefied fluid and thus a safe supply of the containers with the liquefied fluid can be monitored in this way.

In one embodiment variant, the apparatus further has a processing device.

Preferably, the processing device can be configured:
to adapt a supply of the cooling medium from the cooling medium source to the cooling container depending upon a signal output of the cooling medium fill-level sensor, preferably to maintain a predetermined cooling medium fill level at which the storage container is at least partially, preferably completely, immersed in the cooling medium, and the liquefaction device is at least partially immersed in the cooling medium; and/or
to adapt a supply of the gaseous fluid from the fluid gas source to the liquefaction device depending upon a signal output of the liquefied fluid fill-level sensor, preferably to maintain a predetermined liquefied fluid minimum fill level in the storage container.

Advantageously, this makes it possible to ensure safe and continuous operation of the apparatus in a simple manner.

Preferably, the term “processing device” can refer to an electronic plant (e.g., embodied as a driver circuit or with microprocessor(s) and data memory) and/or a mechanical, pneumatic, and/or hydraulic controller which can take over control tasks and/or regulation tasks and/or processing tasks, depending upon the configuration. Although the term “control” is used herein, this can also comprise or be understood as “closed-loop control” or “control with feedback” and/or “processing” as appropriate.

In a further embodiment variant, the liquefaction device has a helical pipeline and/or the liquefaction device is arranged, preferably directly, above the storage container in the cooling container, and/or the liquefaction device, the storage container, the cooling container, and the dosing device form a common structural unit. The advantage of this is that a particularly compact construction can be achieved.

In one exemplary embodiment, the dosing device has a dispensing nozzle for dispensing the liquefied fluid into the container. Preferably, the apparatus can further have a treatment chamber in which the dispensing nozzle is at least partially arranged for treating, preferably tempering and/or rinsing, the dispensing nozzle, wherein, particularly preferably, the treatment chamber is arranged outside the cooling container. This can be advantageous, for example, for preventing the dispensing nozzle from freezing up undesirably.

In a further exemplary embodiment, the apparatus further has a treatment medium line which opens into the treatment chamber for supplying an (e.g., gaseous) treatment medium to the treatment chamber for treating the dispensing nozzle, wherein the treatment medium line is preferably arranged outside the cooling container. Preferably, a treatment medium for treating the dispensing nozzle can be introduced into the treatment chamber, such that, for example, it can be particularly reliably ensured that the dispensing nozzle does not freeze up undesirably.

In one embodiment variant, the apparatus has a heating device connected to the treatment medium line for heating the treatment medium, and/or a temperature sensor connected to the treatment medium line for detecting a temperature of the treatment medium, and/or a treatment medium source, preferably an (e.g., sterile) nitrogen gas source, wherein the treatment medium source is connected, via the treatment medium line, to the treatment chamber for supplying at least part of the treatment medium to the treatment chamber. This advantageously ensures that the treatment chamber is reliably supplied with the treatment medium at the desired temperature.

In a further embodiment variant, the apparatus further has a fluid gas discharge line which is connected to the storage container for discharging a, preferably gaseous, fluid from the storage container. Optionally, the fluid gas discharge line can be connected, via the treatment medium line, to the treatment chamber for supplying the discharged fluid to the treatment chamber as at least a part of the treatment medium. Advantageously, the gaseous fluid from the storage container can thus be used to treat the dispensing nozzle.

In one exemplary embodiment, a liquefied fluid fill-level sensor extends through the fluid gas discharge line into the storage container. This advantageously enables a particularly space-saving arrangement. In addition, for example, when using an insulating container in which the cooling container is arranged, the number of access points/openings in/on the insulating container can be kept as low as possible.

In one embodiment, the apparatus further has a cooling medium discharge line, which is connected to the cooling container for discharging the, preferably evaporated, cooling medium from the cooling container, preferably projecting into the cooling container from above. This can advantageously enable an expansion of the liquid cooling medium in the cooling container.

In a further embodiment, the apparatus further has an insulating container, preferably a vacuum insulating container, wherein the cooling container and the liquefaction device arranged therein and the storage container arranged therein are arranged in the insulating container. This has the advantage of preventing the cooling medium in the container from being heated by the surrounding environment of the apparatus.

In one embodiment, the apparatus further has a capping device with a cap which is selectively movable, preferably pivotable, to block or release a dispensing opening of the dosing device. This can advantageously enable cleaning of the apparatus (e.g., CIP or SIP).

In a further embodiment, the dosing device has an (e.g., elongated) valve element. Preferably, the valve element can be movable for metered dispensing of the liquefied fluid into the container (e.g., for selectively blocking or releasing a dispensing nozzle of the dosing device). Alternatively or additionally, the valve element can be arranged to partially block a fluid connection between the liquefaction device and the storage container for braking the fluid flowing through the liquefaction device, preferably with a valve seat for the valve element in or on the fluid connection. Particularly preferably, the valve element can thus combine a plurality of functions, viz., the metered dispensing of the liquefied fluid into the container on the one hand and the effect as a flow brake to improve the liquefaction of the gaseous fluid in the liquefaction device on the other.

A further aspect of the present disclosure relates to a container treatment plant having a filling apparatus, preferably a rotary filling apparatus, for filling containers with an (e.g., liquid or pasty) filling material. The container treatment plant further has an apparatus as disclosed herein, which is arranged to dispense the liquefied fluid into the containers filled with the contents.

Optionally, the container treatment plant can, for example, also have a closure apparatus which is arranged to close the filled containers supplied with the liquefied fluid.

Preferably, the container processing plant can be configured for tempering, producing, cleaning, coating, testing, filling, closing, pasteurizing, labeling, printing, marking, laser marking, and/or packaging containers for liquid or pasty media, preferably beverages, liquid foodstuffs, or products from the pharmaceutical or healthcare industry.

For example, the containers can be realized as bottles, cans, canisters, cartons, vials, tubes, etc.

Another aspect of the present disclosure relates to a method for dispensing a liquefied (e.g., sterile) fluid, preferably liquefied (e.g., sterile) nitrogen or liquefied (e.g., sterile) oxygen, into a container, preferably by an apparatus as disclosed herein (e.g., in a container treatment plant as disclosed herein). The method comprises:
liquefying a gaseous fluid in a liquefaction device which is immersed at least in portions (e.g., with a helical pipeline) in a cooling medium bath of an (e.g., pressureless or vacuum) cooling container;
storing the liquefied fluid from the liquefaction device in a storage container (e.g., directly below the liquefaction device) which is at least in portions, preferably entirely, immersed in the cooling medium bath of the cooling container; and
dispensing the liquefied fluid from the storage container by a dosing device into the container (e.g., positioned below the dosing device).

Advantageously, the method can achieve the same advantages as already described with reference to the apparatus. The same applies to the preferred exemplary embodiments of the method described below.

In one exemplary embodiment, the method further comprises at least one of the following:
supplying the gaseous fluid from a fluid gas source, preferably a sterile fluid gas source, particularly preferably a sterile nitrogen gas source or a sterile oxygen gas source, to the liquefaction device, preferably depending upon a signal output of an (e.g., thermosensitive) liquefied fluid fill-level sensor which detects a fill level of the liquefied fluid in the storage container;
supplying a cooling medium from a cooling medium source, preferably a cooling liquid source, particularly preferably an (e.g., non-sterile) liquid nitrogen source, to the cooling container, preferably depending upon a signal output of an (e.g., thermosensitive) cooling medium fill-level sensor which detects a fill level of the cooling medium bath;
insulating the cooling container in an insulating container, preferably a vacuum insulating container;
moving a valve element of the dosing device for metered dispensing of the liquefied fluid into the container; and
braking the liquefied fluid in the liquefaction device using a valve element of the dosing device which partially blocks a fluid connection between the liquefaction device and the storage container, preferably with a valve seat for the valve element in or on the fluid connection.

In another exemplary embodiment, the method further comprises the following:
treating, preferably tempering and/or rinsing, a dispensing nozzle of the dosing device in a treatment chamber filled with an (e.g., gaseous) treatment medium.

In another exemplary embodiment, the method further comprises at least one of the following:
heating the treatment medium when supplied to the treatment chamber by a heating device, preferably depending upon a signal output of a temperature sensor which detects a temperature of the treatment medium;
supplying at least a portion of the treatment medium to the treatment chamber from a treatment medium source, preferably an (e.g., sterile) nitrogen gas source; and
supplying, preferably gaseous, fluid from the storage container to the treatment chamber as at least part of the treatment medium (e.g., via a treatment medium line external to the cooling container).

The preferred embodiments and features of the invention described above can be combined with one another as desired.

### BRIEF DESCRIPTION OF THE FIGURES

Further details and advantages of the invention are described below with reference to the accompanying drawings, in which:

FIG. 1 shows a schematic illustration (simplified PID/piping and instrumentation diagram) of an apparatus according to an exemplary embodiment of the present disclosure;

FIG. 2 shows a schematic diagram/sectional view of an exemplary apparatus;

FIG. 3 shows a detail view of a portion of FIG. 2; and

FIG. 4 shows a detail view of another portion of FIG. 2.

The embodiments shown in the drawings correspond at least in part, so that similar or identical parts are provided with the same reference signs, and reference is also made to the description of other embodiments or figures for the explanation thereof to avoid repetition.

### DETAILED DESCRIPTION OF EXEMPLARY EMBODIMENTS

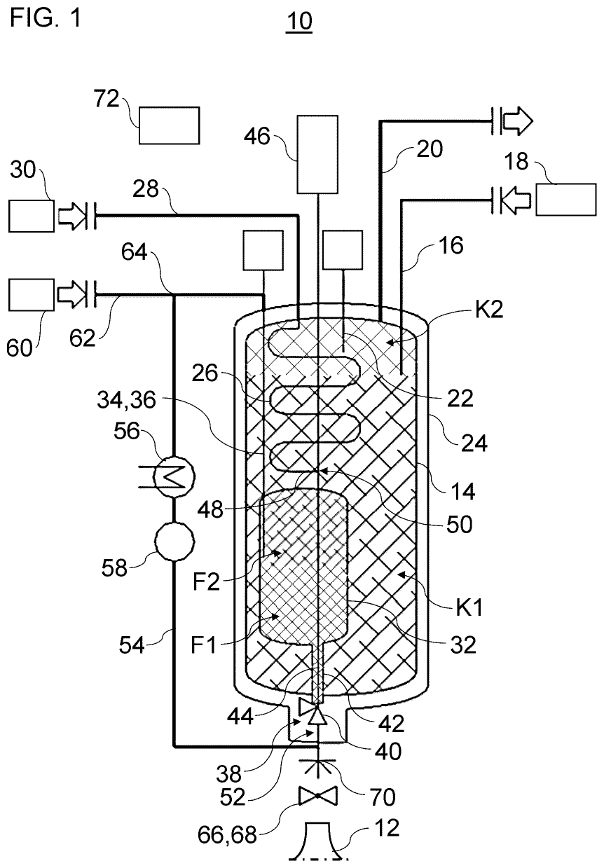

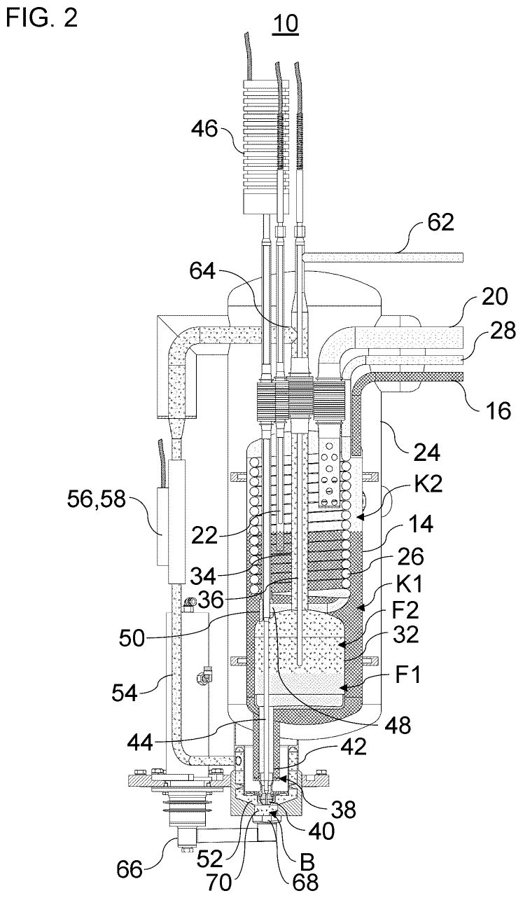

FIGS. 1 to 4 show an apparatus 10 for dispensing a liquefied fluid into a container 12. Preferably, the apparatus 10 is used as a so-called nitrogen dropper for dispensing liquefied nitrogen, preferably sterile nitrogen, into containers 12. However, it is also for example possible for the apparatus 10 to be used to dispense liquefied oxygen, preferably sterile oxygen or pure oxygen, into the containers 12.

Preferably, the apparatus 10 can be included in a container treatment plant (not shown in the figures). For example, the container treatment plant can have a filling apparatus and/or a closure apparatus.

The filling apparatus can fill the containers 12, preferably with a liquid or pasty medium. The filling apparatus is preferably configured as a rotary filling apparatus. The filling apparatus can have a plurality of filling valves for filling a plurality of containers 12 simultaneously or with a temporal overlap. For example, the filling valves can be arranged around a periphery of a filler carousel of the rotary filling apparatus.

The closure apparatus can seal the containers 12—for example, with a lid, a cork, a crown cap, or a screw cap. The closure apparatus can preferably be configured as a rotary closure apparatus. The closure apparatus can have a plurality of closure stations for closing a plurality of containers 12 either simultaneously or with a temporal overlap. For example, the closure stations can be arranged around a periphery of a closure carousel of the rotary closure apparatus. The closure apparatus can be arranged downstream of the filling apparatus in relation to a container stream.

The apparatus 10, in turn, can be arranged to dispense the liquefied fluid into the containers 12 filled with the filling material. For example, the apparatus 10 can be arranged in the region of the filling apparatus, in the region of the closure apparatus, or in the region of a container transport apparatus, which connects the filling apparatus and the closure apparatus to one another.

The apparatus 10 has a cooling container 14, a liquefaction device 26, a storage container 32, and a dosing device 38. Furthermore, the apparatus 10 can have, for example, a cooling medium source 18, a cooling medium fill-level sensor 22, an insulating container 24, a fluid gas source 30, a liquefied fluid fill-level sensor 36, a treatment chamber 52, a heating device 56, a temperature sensor 58, a treatment medium source 60, a capping device 66, and/or a processing device 72.

Particularly preferably, the cooling container 14, the liquefaction device 26, the storage container 32, and the dosing device 38 form a common structural unit. This common unit can include further components, such as components 22, 24, 34, 36, 40, 42, 44, 46, 48, 50, 52, 54, 56, 58, 64, 66, 68, 70, and/or 72.

The cooling container 14 is configured to hold a preferably liquid cooling medium. Preferably, the cooling medium can be liquid nitrogen. Preferably, the liquid nitrogen is non-sterile.

Preferably, the cooling container 14 is partially filled with liquid, preferably pressureless, cooling medium (cooling medium bath) K1, e.g., liquid nitrogen. The cooling medium K1 can, for example, have a temperature of at least −196° C. (77 K). Cooling medium K2 evaporating from the liquid cooling medium K1 can collect in an upper portion of the cooling container 14. For better differentiation, the liquid cooling medium K1 and the evaporated cooling medium K2 are each shown with different hatching in the figures.

It is also conceivable for the temperature of the cooling medium K1 to be reduced to significantly lower than −196° C. For example, a negative pressure could be generated in the gas space of the cooling container 14, i.e., above the cooling medium K1 or where the cooling medium K2 is, e.g., by a vacuum pump connected thereto. This allows, for example, a temperature limit of −210° C. for the cooling medium K1 to be reached before the nitrogen freezes.

The cooling container 14 can have any shape for receiving the cooling medium K1. For example, the cooling container 14 can be substantially cylindrical, e.g., with a curved or flat lower part and/or with a curved or flat upper part. Alternatively, the cooling container 14 can, for example, be substantially spherical or substantially cuboidal.

Preferably, the cooling container 14 can be connected to a cooling medium source 18 via a cooling medium supply line 16. The cooling medium source 18 is preferably a cooling liquid source, e.g., a non-sterile liquid nitrogen source. The cooling medium supply line 16 can open into an upper portion of the cooling container 14, e.g., project into it.

The cooling container 14 can preferably be connected to a cooling medium discharge line 20. Evaporated cooling medium K2 can be discharged from the cooling container 14 via the cooling medium discharge line 20. Preferably, the cooling medium discharge line 20 projects from above into the cooling container 14. An expansion of the cooling medium K1 can thus advantageously take place via the cooling medium discharge line 20.

The cooling medium fill-level sensor 22 can preferably be arranged in the cooling container 14, e.g., project into it. The cooling medium fill-level sensor 22 can detect a fill level of the liquid cooling medium K1 in the cooling container 14. The cooling medium fill-level sensor 22 can also be referred to as a cooling medium fill-level probe.

The cooling medium fill-level sensor 22 can use any known measuring principle to detect the fill level. Preferably, the cooling medium fill-level sensor 22 can be thermosensitive.

Preferably, the cooling medium fill-level sensor 22 projects into the cooling container 14 from above. For example, the cooling medium fill-level sensor 22 in the cooling container 14 can be surrounded by the liquefaction device 26.

Preferably, the cooling container 14 is arranged together with the liquefaction device 26 and the storage container 32 in an insulating container 24. The insulating container 24 is preferably a vacuum insulating container. A vacuum can substantially prevail inside the insulating container 24 in which the cooling container 14 is arranged. An outer peripheral surface of the cooling container 14 can be arranged at a distance from an inner peripheral surface of the cooling container 14.

The insulating container 24 can have any shape for receiving the cooling container 14, etc. For example, the insulating container 24 can be substantially cylindrical, e.g., with a curved or flat lower part and/or with a curved or flat upper part. Alternatively, the insulating container 24 can, for example, be substantially spherical or substantially cuboidal.

The liquefaction device 26 is arranged in the cooling container 14. Preferably, the liquefaction device 26 can be arranged in an upper portion of the cooling container 14. Preferably, the liquefaction device 26 is arranged in the cooling container 14 directly above the storage container 32.

Cooled by the cooling medium K1, K2 in the cooling container 14, the liquefaction device 26 liquefies a gaseous fluid which flows through the liquefaction device 26. The gaseous fluid is preferably sterile, gaseous nitrogen or oxygen.

Preferably, the liquefaction device 26 has a helical (helix-shaped/spiral-shaped) pipeline. The gaseous fluid can flow through the helical pipeline and be cooled and liquefied. Preferably, the liquefaction device 26 or the helical pipeline is at least partially immersed in the liquid cooling medium K1.

Instead of the helical pipeline, however, other shapes and courses for the liquefaction device 26 or its pipeline for the fluid are also conceivable which enable an effective heat exchange with the cooling medium K1, K2 in the cooling container 14 for liquefying the gaseous fluid.

Preferably, the liquefaction device 26 can be connected to a fluid gas source 30 via a fluid gas supply line 28. The fluid gas source 30 can supply the gaseous fluid to the liquefaction device 26 via the fluid gas supply line 28. The fluid gas source 30 is preferably a sterile fluid gas source. Particularly preferably, the fluid gas source 30 is a sterile nitrogen gas source. However, it is also possible for the fluid gas source 30 to be for example a sterile oxygen gas source/pure oxygen gas source. Preferably, the fluid gas supply line 28 can project from above into the cooling container 14 and be connected to the liquefaction device 26.

The storage container 32 is connected to the liquefaction device 26 for receiving the liquefied fluid from the liquefaction device 26, e.g., via a fluid connection 48. The storage container 32 is arranged in the cooling container 14 for cooling the received liquefied fluid. Preferably, the storage container 32 can be arranged in a lower portion of the cooling container 14. Preferably, the storage container 32 is arranged in the cooling container 14 directly below the liquefaction device 26.

The liquefied fluid can be (temporarily) stored or buffered in the storage container 32. Preferably, the storage container 32 is partially filled with liquefied fluid (fluid bath) F1, e.g., liquid sterile nitrogen or liquid sterile oxygen. Fluid F2 evaporated from the liquefied fluid F1, e.g., during flow into the storage container 32, or fluid F2 still in gaseous form from the liquefaction device 26 can collect in an upper portion of the storage container 32. The liquefied fluid F1 can expand in the storage container 32, e.g., to an ambient pressure of the apparatus 10 (e.g., insulator pressure of a clean room in which the apparatus 10 is arranged). For better differentiation, the liquefied fluid F1 and the evaporated fluid F2 are shown in the figures with different hatching.

Since the storage container 32 with the (sterile) liquefied fluid F1 is located in the (non-sterile) liquid cooling medium K1 that is preferably at least −196° C. or colder, this is referred to as subcooled liquid, or so-called liquid subcooling.

The storage container 32 can have any shape for storing the fluid F1, F2. For example, the storage container 32 can be substantially cylindrical, e.g., with a curved or flat lower part and/or with a curved or flat upper part. Alternatively, the storage container 32 can for example be substantially spherical or substantially cuboidal.

Preferably, a fluid gas discharge line 34 can be connected to the storage container 32 for discharging the fluid F2 from the storage container 32. For example, the fluid gas discharge line 34 can be connected to an upper portion of the storage container 32.

The fluid gas discharge line 34 can for example extend upwards from the storage container 32. The fluid gas discharge line 34 can preferably extend out of the cooling container 14. Preferably, at least a portion of the fluid gas discharge line 34 can be surrounded by the liquefaction device 26 (for example, its helical pipeline).

The liquefied fluid fill-level sensor 36 can preferably be arranged in the storage container 32, e.g., project into it. The liquefied fluid fill-level sensor 36 can detect a fill level of the liquefied fluid F1 in the storage container 32. The liquefied fluid fill-level sensor 36 can also be referred to as a liquefied fluid fill-level probe.

The liquefied fluid fill-level sensor 36 can use any known measuring principle to detect the fill level. Preferably, the liquefied fluid fill-level sensor 36 can be thermosensitive.

Preferably, the liquefied fluid fill-level sensor 36 projects into the storage container 32 from above. Particularly preferably, the liquefied fluid fill-level sensor 36 can extend through the fluid gas discharge line 34 into the storage container 32. Preferably, at least a portion of the liquefied fluid fill-level sensor 36 can be surrounded by the liquefaction device 26 (for example, its helical pipeline).

The dosing device 38 is configured to dispense the liquefied fluid F1 into the container 12. The container 12 can be arranged below the dosing device 38.

The dosing device 38 is connected to the storage container 32. The dosing device 38 receives the liquefied fluid F1 from the storage container 32.

The dosing device 38 preferably has a dispensing nozzle 40 and a valve element 44.

The dispensing nozzle 40 can dispense the liquefied fluid F1 into the container 12. Preferably, the dispensing nozzle 40 can be connected to the storage container 32 via an outlet line 42. Preferably, the outlet line 42 can extend vertically. For example, the outlet line 42 can be connected to a lower portion of the storage container 32 and to an upper portion of the dispensing nozzle 40.

Particularly preferably, the outlet line 42 is surrounded by a portion of the cooling container 14 and thus by liquid cooling medium K1. This portion of the cooling container 14 can preferably in turn be surrounded by a portion of the insulating container 24.

The valve element 44 is preferably movable for metered dispensing of the liquefied fluid F1 into the container 12. For example, the valve element 44 can selectively open or block an inlet of the dispensing nozzle 40. Metering by the valve element 44 and the dispensing nozzle 40 can be carried out both continuously and discontinuously.

A movement of the valve element 44 can be driven in any way. For example, a drive unit 46 of the apparatus 10 can drive the valve element 44 to move. The drive unit 46 can for example be a mechanical, electrical, electromagnetic, pneumatic, or hydraulic drive unit. The drive unit 46 can for example be arranged above the insulating container 24.

Preferably, the valve element 44 can be elongated—for example, rod-shaped. The valve element 44 preferably extends through the insulating container 24, the cooling container 14, the storage container 32, and/or the outlet line 42. Preferably, a portion of the valve element 44 can be surrounded by the liquefaction device 26 (e.g., its helical pipeline).

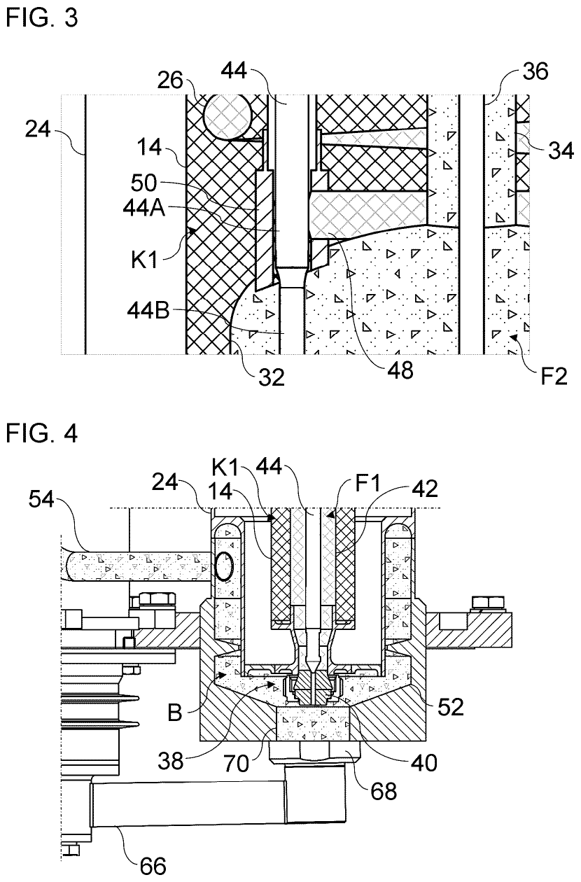

The valve element 44 can preferably also serve as an (active) flow brake for the liquefied fluid in the liquefaction device 26 before it flows into the storage container 32. That is, the valve element 44 is preferably arranged to partially block a fluid connection 48 between the liquefaction device 26 and the storage container 32 (see in particular FIG. 3).

The valve element 44 can be configured such that the effect as a flow brake or for braking the liquefied fluid in the liquefaction device 26 is achieved regardless of whether the valve element 44 is blocking or releasing the dispensing nozzle 40 for the metered dispensing of the liquefied fluid F1. In particular, the valve element 44 can preferably have a thickened portion 44A that is dimensioned (long) such that it completely or partially blocks the fluid connection 48 when the valve element 44 blocks the dispensing nozzle 40 and when the valve element 44 releases the dispensing nozzle 40.

It is possible for the valve element 44 to additionally have a thinned portion 44B. The thinned portion 44B can release a flow cross-section of the fluid connection 48 that is larger than the thickened portion 44A when the cross-section is positioned in the fluid connection 48 by a corresponding movement of the valve element 44. This can be desirable for example if the flow brake is to be deactivated in other necessary process steps (e.g., sterilization, drying, emptying), so that a larger volume flow through the fluid connection 48 is enabled.

Particularly preferably, a valve seat 50 of the valve element 44 can be arranged directly in or adjacent to the fluid connection 48 in order to enable the partial blocking of the flow or the action as a flow brake.

Preferably, the dispensing nozzle 40 can be arranged at least partially in the treatment chamber/nozzle chamber 52. The dispensing nozzle 40 can be treated in the treatment chamber 52. For example, the dispensing nozzle 40 can be tempered and/or rinsed in the treatment chamber 52.

A treatment medium line 54 can open into the treatment chamber 52 for supplying a treatment medium B to the treatment chamber 52. Preferably, the treatment medium line 54 can be arranged outside the cooling container 14 and/or the insulating container 24. For example, a portion of the treatment medium line 54 can extend parallel to a vertical axis of the cooling container 14.

Preferably, the heating device 56 can be connected to the treatment medium line 54 for heating the treatment medium B. For example, the heating device 56 can heat the treatment medium B while it flows through the treatment medium line 54.

Preferably, the temperature sensor 58 can be connected to the treatment medium line 54 to detect a temperature of the treatment medium B. Preferably, the temperature sensor 58 can be adjacent to the heating device 56.

The treatment medium source 60 can, for example, be a sterile treatment medium source, e.g., a sterile nitrogen gas source. Preferably, the treatment medium source 60 can be connected, via the treatment medium line 54, to the treatment chamber 52 for supplying at least a portion of the treatment medium B to the treatment chamber 52.

Particularly preferably, the fluid gas discharge line 34 is connected to the treatment chamber 52 via the treatment medium line 54. Via the fluid gas discharge line 34, vaporized/gaseous fluid F2 can be supplied from the storage container 32 to the treatment chamber 52 as at least a part of the treatment medium B. Preferably, the treatment medium B can thus originate partly from the treatment medium source 60 and partly from the storage container 32.

For example, a supply line 62 from the treatment medium source 60 and the fluid gas discharge line 34 can open into at least one inlet portion 64 of the treatment medium line 54. Preferably, the fluid gas discharge line 34 and the supply line 62 open together into the same inlet portion 64. Preferably, the inlet portion 64 can be arranged in the insulating container 24 and/or outside the cooling container 14. For example, the inlet portion 64 can be arranged above the cooling container 14 in the insulating container 24.

The capping device 66 can have a movable cap 68. The cap 68 is preferably movable such that it can selectively block or release a dispensing opening 70 of the dosing device 38. Preferably, the dispensing opening 70 can correspond to an outlet of the dispensing nozzle 40 or be arranged directly below the dispensing nozzle 40. It is possible for the discharge opening 70 to be a bottom-side opening of the treatment chamber 52.

Preferably, the cap 68 is pivotable between the release position and the blocking position. The cap 68 can be a cleaning cap, e.g., a CIP (cleaning-in-place) cap or an SIP (sterilizing-in-place) cap, with which the dispensing opening 70 can be closed for cleaning the apparatus 10 or for other process steps.

The processing device 72 (shown only schematically in FIG. 1) can be configured to operate the apparatus 10.

For example, the processing device 72 can be configured to operate the drive unit 46 to move the valve element 44 to dispense the liquefied fluid F1 from the apparatus 10 into the container 12.

For example, the processing device 72 can be configured to adjust a supply of the cooling medium from the cooling medium source 18 to the cooling container 14 depending upon a signal output of the cooling medium fill-level sensor 22. Preferably, a predetermined cooling medium fill level can be maintained in this way at which the storage container 32 is at least partially, preferably completely, immersed in the cooling medium K1, and the liquefaction device 26 is at least partially immersed in the cooling medium K1.

For example, the processing device 72 can be configured to adjust a supply of the gaseous fluid from the fluid gas source 30 to the liquefaction device 26 depending upon a signal output of the liquefied fluid fill-level sensor 36. Preferably, in this way, a predetermined minimum liquefied fluid fill level in the storage container 32 can be maintained.

For example, the processing device 72 can be configured to operate the heating device 56 for heating the treatment medium B flowing through the treatment medium line 54 depending upon a signal output of the temperature sensor 58. Preferably, a minimum temperature for the treatment medium B can be achieved in this way.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the cooling container, the liquefaction device, the storage container, and/or the dosing device of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus
12 container
14 cooling container
16 cooling medium supply line
18 cooling medium source
20 cooling medium discharge line
22 cooling medium fill-level sensor
24 insulating container
26 liquefaction device
28 fluid gas supply line
30 fluid gas source
32 storage containers
34 fluid gas discharge line
36 liquefied fluid fill-level sensor
38 dosing device
40 dispensing nozzle
42 outlet line
44 valve element
44A thickened portion
44B thinned portion
46 drive unit
48 fluid connection
50 valve seat
52 treatment chamber
54 treatment medium line
56 heating device
58 temperature sensor
60 treatment medium source
62 supply line
64 inlet portion
66 capping device
68 cap
70 dispensing opening
72 processing device
B treatment medium
F1 liquefied fluid/fluid bath
F2 vaporized/gaseous fluid
K1 liquid cooling medium/cooling medium bath
K2 evaporated cooling medium

What is claimed is:

1. An apparatus for dispensing a liquefied fluid into a container, wherein the apparatus comprises:
a cooling container for receiving a cooling medium;
a liquefaction device arranged in the cooling container for cooling and liquefying a gaseous fluid;
a storage container connected to the liquefaction device for receiving the liquefied fluid from the liquefaction device and arranged in the cooling container for cooling the liquefied fluid; and
a dosing device for dispensing the liquefied fluid into the container, wherein the dosing device is connected to the storage container for receiving the liquefied fluid from the storage container.

2. The apparatus according to claim 1, further having at least one of:
a fluid gas source connected to the liquefaction device for supplying the gaseous fluid to the liquefaction device; and
a cooling medium source connected to the cooling container for supplying the cooling medium to the cooling container.

3. The apparatus according to claim 2, further having at least one of:
a cooling medium fill-level sensor arranged in the cooling container for detecting a fill level of the cooling medium; and
a liquefied fluid fill-level sensor arranged in the storage container for detecting a fill level of the liquefied fluid.

4. The apparatus according to claim 3, further having a processing device that is configured at least one of:
to adapt a supply of the cooling medium from the cooling medium source to the cooling container depending upon a signal output of the cooling medium fill-level sensor; and
to adapt a supply of the gaseous fluid from the fluid gas source to the liquefaction device depending upon a signal output of the liquefied fluid fill-level sensor.

5. The apparatus according to claim 4, wherein at least one of:
the apparatus includes a nitrogen dropper;
the apparatus dispenses one of nitrogen and oxygen into the container;
the cooling medium is liquid;
the fluid gas source is at least one of a sterile fluid gas source, a sterile nitrogen gas source and a sterile oxygen gas source;
the cooling medium source is at least one of a cooling liquid source and a liquid nitrogen source;
the cooling medium fill-level sensor is thermosensitive;
the liquefied fluid fill-level sensor is thermosensitive; and
the processing device is further configured at least one of to maintain a predetermined cooling medium fill level at which the storage container is at least partially immersed in the cooling medium and the liquefaction device is at least partially immersed in the cooling medium, and to maintain a predetermined liquefied fluid minimum fill level in the storage container.

6. The apparatus according to claim 1, wherein at least one of the following is met:
the liquefaction device has a helical pipeline;
the liquefaction device is arranged above the storage container in the cooling container; and
the liquefaction device, the storage container, the cooling container, and the dosing device form a common structural unit.

7. The apparatus according to claim 1, wherein the dosing device has a dispensing nozzle for dispensing the liquefied fluid into the container, wherein the apparatus further has a treatment chamber in which the dispensing nozzle for treating is at least partially arranged.

8. The apparatus according to claim 7, further having:
a treatment medium line which opens into the treatment chamber for supplying a treatment medium to the treatment chamber for treating the dispensing nozzle,
wherein the apparatus further has at least one of the following:
a heating device connected to the treatment medium line for heating the treatment medium;
a temperature sensor connected to the treatment medium line for detecting a temperature of the treatment medium; and
a treatment medium source connected via the treatment medium line to the treatment chamber for supplying at least a portion of the treatment medium to the treatment chamber.

9. The apparatus according to claim 8, further having:
a fluid gas discharge line which:
is connected to the storage container for discharging a fluid from the storage container; and
is connected, via the treatment medium line, to the treatment chamber for supplying the discharged fluid to the treatment chamber as at least part of the treatment medium.

10. The apparatus according to claim 9, wherein a liquefied fluid fill-level sensor extends through the fluid gas discharge line into the storage container.

11. The apparatus according to claim 9, wherein at least one of:
the dispensing nozzle for treating is for at least one of tempering and rinsing;
the treatment chamber is arranged outside the cooling container;
the treatment medium line is arranged outside the cooling container;
the treatment medium source is a nitrogen gas source; and
the fluid is gaseous.

12. The apparatus according to claim 1, further having at least one of:
a cooling medium discharge line, which is connected to the cooling container for discharging the cooling medium from the cooling container;
an insulating container, wherein the cooling container and the liquefaction device arranged therein and the storage container arranged therein are arranged in the insulating container; and
a capping device with a cap which is selectively movable to block or release a dispensing opening of the dosing device.

13. The apparatus according to claim 1, wherein:
the dosing device has a valve element which at least one of:
is movable for metered dispensing of the liquefied fluid into the container; and
is arranged to partially block a fluid connection between the liquefaction device and the storage container for braking the fluid flowing through the liquefaction device.

14. The apparatus according to claim 1, wherein at least one of:
the liquefaction device is arranged directly above the storage container in the cooling container;
the dosing device has a valve element which is arranged to partially block a fluid connection between the liquefaction device and the storage container for braking the fluid flowing through the liquefaction device with a valve seat for the valve element in or on the fluid connection;
the apparatus includes a cooling medium discharge line connected to the cooling container for discharging the evaporated cooling medium from the cooling container;
the apparatus includes the cooling medium discharge line connected to the cooling container for discharging the cooling medium from the cooling container projecting into the cooling container from above;
the apparatus includes a vacuum insulating container, wherein the cooling container and the liquefaction device arranged therein and the storage container arranged therein are arranged in the vacuum insulating container; and
the apparatus includes a capping device with a cap which is selectively pivotable to block or release a dispensing opening of the dosing device.

15. A container processing system, having:
a filling apparatus for filling containers with a filling material; and
the apparatus of claim 1, which is arranged to dispense the liquefied fluid into the containers filled with the filling material.

16. A method for dispensing a liquefied fluid into a container, wherein the method comprises:
liquefying a gaseous fluid in a liquefaction device at least portions of which are immersed in a cooling medium bath of a cooling container;
storing the liquefied fluid from the liquefaction device in a storage container immersed at least in portions in the cooling medium bath of the cooling container; and
dispensing the liquefied fluid from the storage container into the container by a dosing device.

17. The method of claim 16, wherein at least one of:
the liquefied fluid is one of liquefied nitrogen and liquefied oxygen;
the storing the liquefied fluid from the liquefaction device in the storage container is immersed entirely in the cooling medium bath of the cooling container; and
the method dispenses the liquefied fluid using an apparatus including:
a cooling container for receiving a cooling medium,
a liquefaction device arranged in the cooling container for cooling and liquefying a gaseous fluid,
a storage container connected to the liquefaction device for receiving the liquefied fluid from the liquefaction device and arranged in the cooling container for cooling the liquefied fluid, and
a dosing device for dispensing the liquefied fluid into the container, wherein the dosing device is connected to the storage container for receiving the liquefied fluid from the storage container.

18. The method according to claim 16, further comprising at least one of:
supplying the gaseous fluid from a fluid gas source to the liquefaction device;
supplying a cooling medium from a cooling medium source to the cooling container;
insulating the cooling container in an insulating container, preferably a vacuum insulating container;
moving a valve element of the dosing device for metered dispensing of the liquefied fluid into the container; and
braking the liquefied fluid in the liquefaction device by a valve element of the dosing device, which partially blocks a fluid connection between the liquefaction device and the storage container, preferably with a valve seat for the valve element in or on the fluid connection.

19. The method according to claim 18, wherein at least one of:
the fluid gas source is at least one of a sterile fluid gas source, a sterile nitrogen gas source and a sterile oxygen gas source;
the supplying the gaseous fluid from the fluid gas source to the liquefaction device depends upon a signal output of a liquefied fluid fill-level sensor which detects a fill level of the liquefied fluid in the storage container;
the cooling medium source is at least one of a cooling liquid source and a liquid nitrogen source
the supplying the cooling medium from the cooling medium source to the cooling container depends upon a signal output of a cooling medium fill-level sensor which detects a fill level of the cooling medium bath;
the insulating container is a vacuum insulating container;
the braking the liquefied fluid in the liquefaction device by the valve element is with a valve seat for the valve element in or on the fluid connection; and
the method further includes at least one of:
treating, via at least one of tempering and rinsing, a dispensing nozzle of the dosing device in a treatment chamber which is filled with a treatment medium,
heating the treatment medium when it is fed to the treatment chamber by a heating device depending upon a signal output of a temperature sensor which detects a temperature of the treatment medium,
supplying at least a portion of the treatment medium from a nitrogen gas source to the treatment chamber, and
supplying gaseous fluid from the storage container to the treatment chamber as at least part of the treatment medium.

20. The method according to claim 16, further comprising treating a dispensing nozzle of the dosing device in a treatment chamber which is filled with a treatment medium.
